(19) United States
(12) Patent Application Publication
(10) Pub. No.: US 2017/0048685 A1
(43) Pub. Date: Feb. 16, 2017

(54) Real-Time Parental Monitoring

(71) Applicant: Microsoft Technology Licensing, LLC, Redmond, WA (US)

(72) Inventor: Howard Wolosky, Seattle, WA (US)

(73) Assignee: Microsoft Technology Licensing, LLC, Redmond, WA (US)

(21) Appl. No.: 14/827,267

(22) Filed: Aug. 14, 2015

(51) Int. Cl. H04W 4/14; H04L 29/08; H04L 12/58

(52) U.S. Cl. CPC H04W 4/14; H04L 51/12; H04L 67/306

(57) ABSTRACT

In one embodiment, an administrative user may monitor the device messaging of a child user. A network service may associate an administrative network service account with a child network service account. The network service may transfer one or more administrative messaging rules from the administrative network service account to the child network service account. The network service may propagate the one or more administrative messaging rules to an independent child user device for implementation when a child user exchanges a device message via the independent child user device.

### BACKGROUND

A user may use a personal user device to send a message to another personal user device across a cellular network. A device message is a message traditionally sent across a cellular network, although in some circumstances a data network may be used where available. The device message may be a short messaging service (SMS) message, a multi-media service (MMS) message, an internet protocol (IP) message, an instant message (IM), or a rich communication services (RCS) message. While in the past such messages tended to be tied to a specific user device, a user may compose the device message on an alternate user device. The alternate user device may connect to the personal user device on a data network to use the personal user device as a gateway to the cellular network.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to monitor the device messaging of a user. A network service may associate an administrative network service account with a child network service account. The network service may transfer one or more administrative messaging rules from the administrative network service account to the child network service account. The network service may propagate the one or more administrative messaging rules to an independent child user device for implementation when a child user exchanges a device message via the independent child user device.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a device network.

FIG. 2 illustrates, in a block diagram, one embodiment of a computing device.

FIG. 3 illustrates, in a block diagram, one embodiment of a network service architecture.

FIG. 4a illustrates, in a block diagram, one embodiment of an application-specific child user device architecture.

FIG. 4b illustrates, in a block diagram, one embodiment of an application-agnostic child user device architecture.

FIG. 5 illustrates, in a block diagram, one embodiment of an administrative messaging rule instruction.

FIG. 6 illustrates, in a block diagram, one embodiment of a notification rule instruction.

FIG. 7 illustrates, in a block diagram, one embodiment of a message report.

FIG. 8 illustrates, in a flowchart, one embodiment of a method of controlling device messaging with an administrative user device.

FIG. 9 illustrates, in a flowchart, one embodiment of a method of monitoring device messaging with an administrative user device.

FIG. 10 illustrates, in a flowchart, one embodiment of a method of controlling device messaging with a network service.

FIG. 11 illustrates, in a flowchart, one embodiment of a method of monitoring device messaging with a network service.

FIG. 12 illustrates, in a flowchart, one embodiment of a method of establishing an administrative messaging rule with an independent child user device.

FIG. 13 illustrates, in a flowchart, one embodiment of a method of device messaging with an independent child user device.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a network service server, a computing device, or a machine-implemented method.

In one embodiment, one or more users may monitor the device messaging of a different user by using a network service. The network service may be a network storage or other service used to provide consistency of user experience across user devices. Typically, a user may sign in to the network service by logging in to the operating system with a network service password upon powering up the device. The operating system may then connect the user device to the network service. The operating system may configure various user interfaces and applications on affiliated user devices to comply with settings established by the user and stored in a network storage by a network service account to provide consistency of user experience across each device of a user. A user, such as a parent, may use a network service account to act in an administrative capacity towards a subordinate user, such as a child. The administrative user may establish settings in an administrative network service account that are transferred to the child networks service account of the child user. The child user in this instance does not necessarily refer to an actual child but any subordinate user. The child user may be subordinate to multiple administrative users, with each administrative user being able to edit settings and approve communications.

A network service may associate an administrative network service account of the administrative user with a child network service account of the child user. The network service may transfer one or more administrative messaging rules from the administrative network service account to the child network service account. The network service may propagate the one or more administrative messaging rules to a child user device for implementation when a child user exchanges a device message via the child user device. The child user device may be independent from direct control by the administrative user.

The independent child user device may access a child network service account. The independent child user device may receive from the child network service account an administrative messaging rule transferred from an administrative network service account. The independent child user device may store the administrative messaging rule in memory. The independent child user device may apply the administrative messaging rule when a child user exchanges, either sending or receiving, a device message via the computing device.

The administrative user device may access an administrative network service account. The administrative user device may generate an administrative messaging rule for implementation when a child user exchanges a device message via an independent child user device. The administrative user device may send the administrative messaging rule to an administrative network service account for application to the independent child user device via a child network service account.

The administrative user may indicate in the administrative messaging rule whether monitoring is to be passive or active. In passive monitoring, the child user device may apply the administrative messaging rule to determine whether to exchange the device message without input from the administrative user. In active monitoring, the child user device may apply the administrative messaging rule to determine whether to request input from the administrative user regarding whether to exchange the device message. The administrative user may review the device message, and inform the network service or the child user device whether the child user device may exchange the device message. The administrative messaging rule may set an optional timeout configuration for the child user device to automatically allow or block the device message. Once notified, the network service may complete the respective exchange action, either sending the outgoing message out to the respective service or processing the incoming message for presentation to the child user.

The child user device may send the permission request via the network service. Alternately, the child user device may send the permission request via a permission request device message. The permission request device message may be invisible to the child user. The permission request device message may use special formatting to indicate the requested action, with a hash and timestamp of the device message. The permission request device message may have a digital signature with the device message to ensure the permission request is not improperly spoofed. The child user device may create the digital signature using public key cryptography. Alternately, the child user device may create the digital signature using a keyed hashing algorithm based on the device message, the sender, the receiver, and the timestamp as the key to the algorithm.

The administrative user device may also access a message history for the child user device using the network service. The child user device may mirror a device message to the child network service account as a message representation. The message representation of the device message may have at least one of a metadata description of the device message and a content copy of the device message. The metadata description may describe non-content aspects of the device message, such as the recipient, the sender, the time sent, and the data size of the device message. The content copy may reproduce of a copy of the content sent in the device message, such as any text, audio files, digital images, or video files. The network service may transfer the message representation from the child network service account to the administrative network service account. The administrative user device may access the message representation of the device message in the administrative network service account.

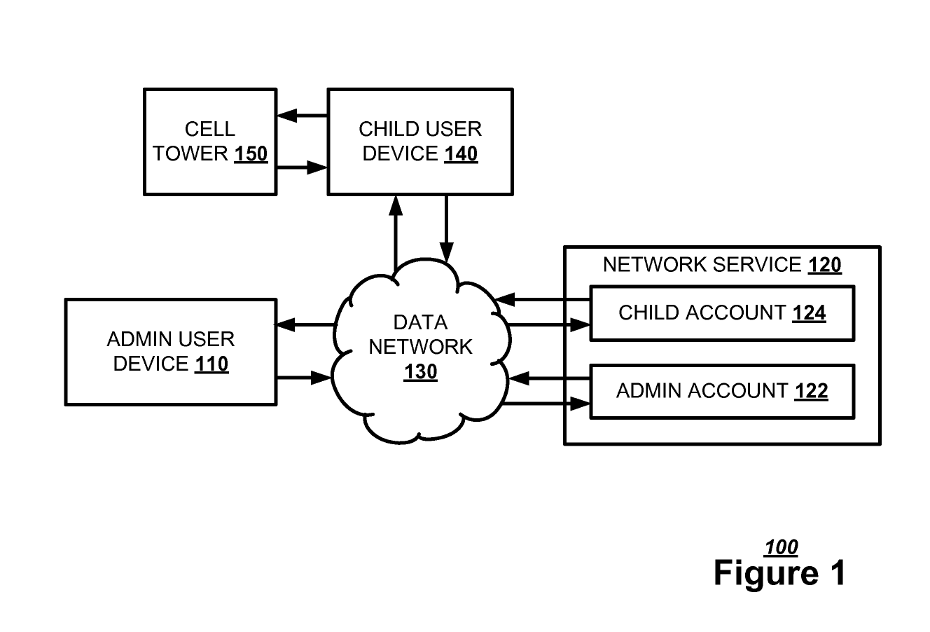

FIG. 1 illustrates, in a block diagram, one embodiment of a device network 100. An administrative user may use an administrative user device 110 to access a network service 120, or “cloud” service, via a data network connection 130. An administrative user is any user that has a different user who is subordinate to that user, such as a parent to a child. The administrative user device 110 may be a personal computer, a laptop, a tablet, a mobile phone, a smart watch, or other computing device used by the administrative user. The network service 120 may be implemented on a single server or a distributed set of servers, such as a server farm. The data network connection 130 may be an internet connection, a wide area network connection, a local area network connection, or other type of data network connections. The administrative user device 110 may use a communication application, a dedicated network service application, or an operating system to access an administrative network service account 122 in the network service 120. The administrative user device 110 may use the administrative network service account 122 to access a network service resource of the network service 120, such as network data storage. The administrative user may store settings for the administrative user device 110 in the network data storage of the network service 120. The administrative network service account 122 may map the same user experience across multiple administrative user devices 110 based on settings for the administrative user stored in the network data storage.

A user, such as a parent, may use the administrative network service account 122 to designate the network service account of a second user, such as a child, as subordinate, referred to herein as a child network service account 124. The child user may be a subordinate adult. Upon designation, the network service 120 may query the child network service account 124 whether such a designation is accepted. Upon acceptance, the network service 120 may associate the administrative network service account 122 with the child network service account 124. The administrative network service account 122 may then set the policies and configurations for any child user devices 140 associated with the child network service account 124. The network service may migrate these policies and configurations from the administrative network service account 122 to the child network service account 124. The child user device 140 may be an independent child user device 140, in that the administrative user may not have direct physical access to the child user device 140. Rather, any interaction by the administrative user with the child user may occur via the network service 120.

A child user device 140 may access the network service 120 via the data network connection 130. The child user device 140 may be a personal computer, a laptop, a tablet, a mobile phone, a smart watch, or other computing device used by the child user. The child user device 140 may use a communication application, a dedicated network service application, or an operating system to access the child network service account 124 in the network service 120. The child user device 140 may use the child network service account 124 to access a network service resource of the network service 120, such as network data storage. The child user may store settings for the child user device 140 in the network data storage of the network service 120. The child network service account 124 may map the same user experience across multiple child user devices 140 based on settings for the child user stored in the network data storage. The child user device 140 may access a cellular network via a cell tower 150. The child user device 140 may send a device message to other devices, either via the cell tower 150 or the data network 130. The administrative user may use the network service 120 to control and monitor the device messaging of the child user.

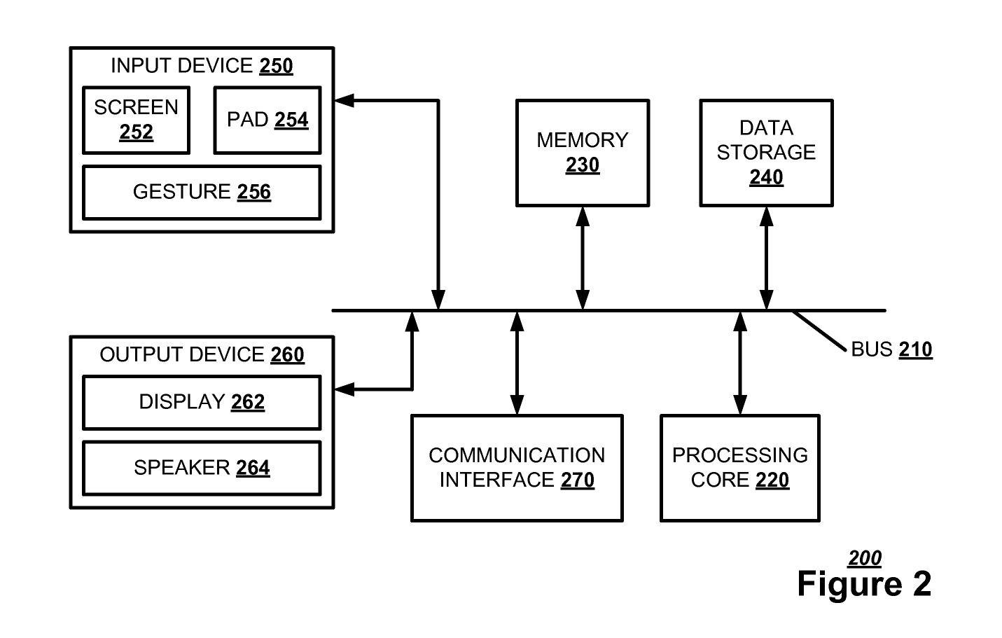

FIG. 2 illustrates a block diagram of an exemplary computing device 200 which may act as an administrative user device, an independent child user device, or a network service server. The computing device 200 may combine one or more of hardware, software, firmware, and system-on-a-chip technology to implement an administrative user device, an independent child user device, or a network service server. The computing device 200 may include a bus 210, a processing core 220, a memory 230, a data storage 240, an input device 250, an output device 260, and a communication interface 270. The bus 210, or other component interconnection, may permit communication among the components of the computing device 200.

The processing core 220 may include at least one conventional processor or microprocessor that interprets and executes a set of instructions. At a network service server, the processing core 220 may be configured to transfer an administrative messaging rule from the administrative network service account to the child network service account. The processing core 220 may be configured to synchronize a message representation of the device message from the child network service account to the administrative network service account. The processing core 220 may be configured to apply a notification rule to the device message.

The memory 230 may be a random access memory (RAM) or another type of dynamic data storage that stores information and instructions for execution by the processing core 220. The memory 230 may also store temporary variables or other intermediate information used during execution of instructions by the processing core 220. At the network service server, the memory 230 may be configured to associate an administrative network service account with a child network service account. The memory 230 may be configured to associate at least one of a visual user tag and a visual device tag with a message representation for a device message by the child user in the administrative network service account.

The data storage 240 may include a conventional ROM device or another type of static data storage that stores static information and instructions for the processing core 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing administrative messaging rules, notification rules, and a messaging history.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The output device 260 may include one or more conventional mechanisms that output information to the user, including a display screen 262, a printer, one or more speakers 264, a headset, a vibrator, or a medium, such as a memory, or a magnetic or optical disk and a corresponding disk drive.

The communication interface 270 may include any transceiver-like mechanism that enables computing device 200 to communicate with other devices or networks, such as data networks and cellular networks. The communication interface 270 may include a network interface, a transceiver interface, or a cellular interface. The communication interface 270 may be a wireless, wired, or optical interface. At the network service server, the communication interface 270 may be configured to propagate the administrative messaging rule to an independent child user device for implementation when a child user exchanges a device message via the independent child user device. The communication interface 270 may be configured to send the administrative messaging rule to a rule broker resident in at least one of a messaging application and an operating system of the independent child user device. The communication interface 270 may be configured to receive the administrative messaging rule from an administrative user device. The administrative messaging rule may be at least one of a content filter, a frequency cap, a quantity cap, an address list, a messaging schedule, or a geographic limitation. The administrative messaging rule may further indicate whether the monitoring of the child user device is to be active or passive.

The communication interface 270 may be configured to receive a message representation of the device message from the independent child user device in the child network service account. The message representation of the device message may have at least one of a metadata description of the device message and a content copy of the device message. The communication interface 270 may be configured to receive a notification rule from an administrative user device. The notification rule may be at least one of a content trigger, a frequency threshold, a quantity threshold, an address list, a schedule trigger, or a geographic trigger. The communication interface 270 may be configured to send a message notification regarding the device message to an administrative user device.

The computing device 200 may perform such functions in response to processing core 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

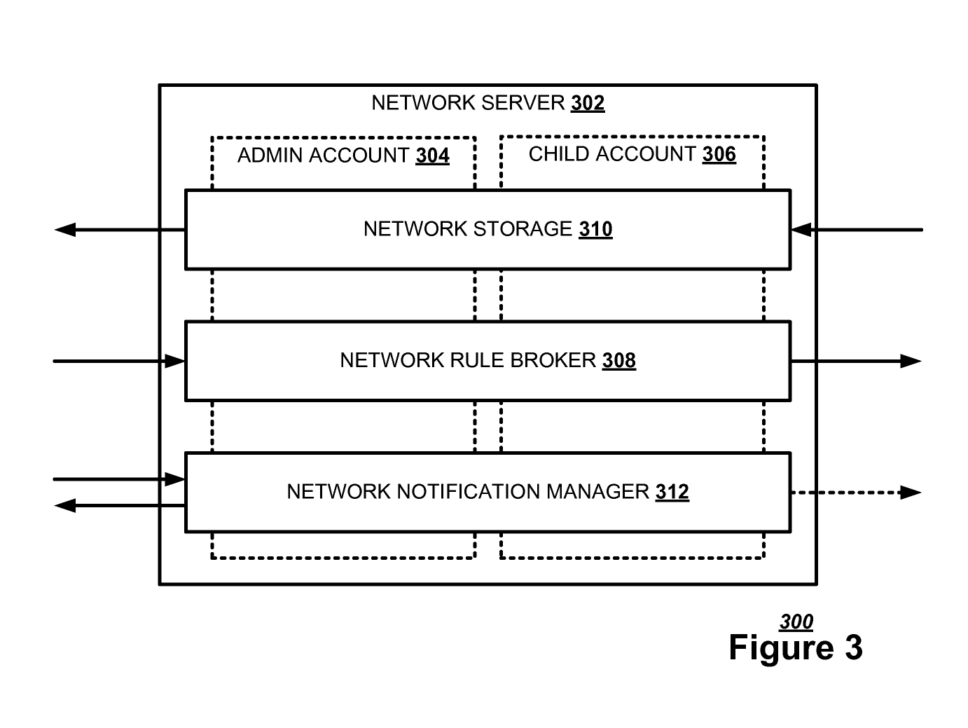

FIG. 3 illustrates, in a block diagram, one embodiment of a network service architecture 300. One or more network service servers 302 may operate the network service. The network service may maintain an administrative network service account 304 for an administrative user. The network service may maintain a child network service account 306 for a child user. The network service may implement a network rule broker 308 that receives in the administrative network service account 304 an administrative messaging rule describing the criteria under which a child user may exchange a device message, either sending or receiving. The network rule broker 308 may transfer the administrative messaging rule from the administrative network service account 304 to the child network service account 306. The child network service account 306 may then propagate the administrative messaging rule to any child user device associated with the child network service account 306. The child user device may then apply the administrative messaging rule before exchanging a device message. Alternately, if the child user device uses the child network service account 306 to exchange the device message over a data network, the network rule broker 308 may apply the administrative messaging rule directly.

For each device message a child user device exchanges, the child user device may mirror that device message in a network storage 310 via the child network service account 306. The child network service account 306 may store a message representation of the device message with a complete content copy of the device message or just a metadata description of the device message. The network storage 310 may associate the message representation with a visual user tag and a visual device tag. The visual user tag visually represents the child user that sent or received the device message when presented to the administrative user. For example, the visual user tag may be a small digital image of the user. The visual device tag visually represents the child user device that sent or received the device message when presented to the administrative user. For example, the visual device tag may be a color coding applied to a digital image of the user. The administrative user may use the administrative network service account 304 to access the message representation in the network storage 310. The administrative user device may then present the message representation, as well as any associated visual tags, to the administrative user.

The administrative user may provide via the administrative network service account 304 a notification rule describing the criteria under which the administrative user is to be notified about a device message sent by a child user device. The network notification manager 312 may apply the notification rule to any device messages sent by the child user device. If the content or the metadata of a device message stored in the network storage 310 by the child network service account 306 meets the criteria of the notification rule, the network notification manager 312 may send a message notification to an administrative user via the administrative network service account 304.

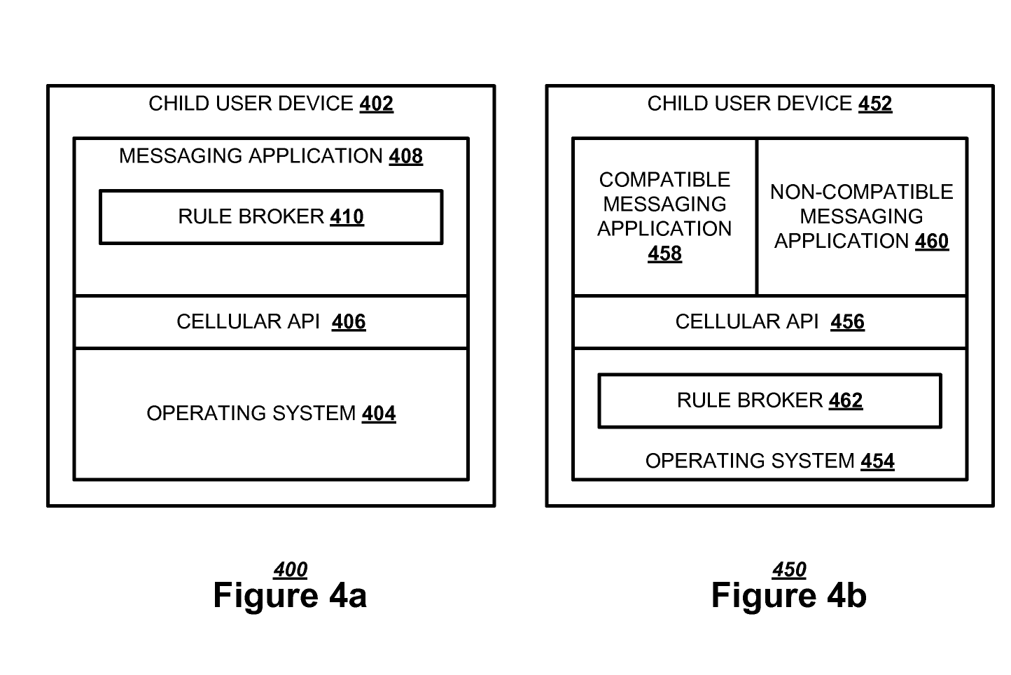

The child user device may use a rule broker to apply the administrative messaging rule. The placement of the rule broker may vary based on user criteria, such as whether narrow coverage or application flexibility is desired. FIG. 4a illustrates, in a block diagram, an application-specific child user device architecture 400. A child user device 402 may implement an operating system 404 as a platform for executing a cellular application programming interface (API) 406 to allow an application to access a cellular radio on the child user device 402. The child user device 402 may execute a messaging application 408 to exchange a device message on a cellular network or a data network. The messaging application 408 may implement a rule broker 410 resident in the messaging application 408 to apply an administrative messaging rule to any device messages the child user exchanges via the messaging application 408. This configuration reduces the footprint of the administrative messaging rule on the child user device 402 to the messaging application 408.

FIG. 4b illustrates, in a block diagram, an application-agnostic child user device architecture 450. A child user device 452 may implement an operating system 454 as a platform for executing a cellular application programming interface 456 to allow an application to access a cellular radio on the child user device 452. The child user device 452 may execute a messaging application 458 directly compatible with a network service to exchange a device message on a cellular network or a data network. Additionally, the child user device 452 may execute a messaging application 460 not directly compatible with a network service to exchange a device message on a cellular network or a data network. The operating system 454 may implement a rule broker 462 resident in the operating system 454 to apply an administrative messaging rule to any device messages exchanged by the child user device 452, regardless of the messaging application used. This configuration increases application flexibility for the child user device 452.

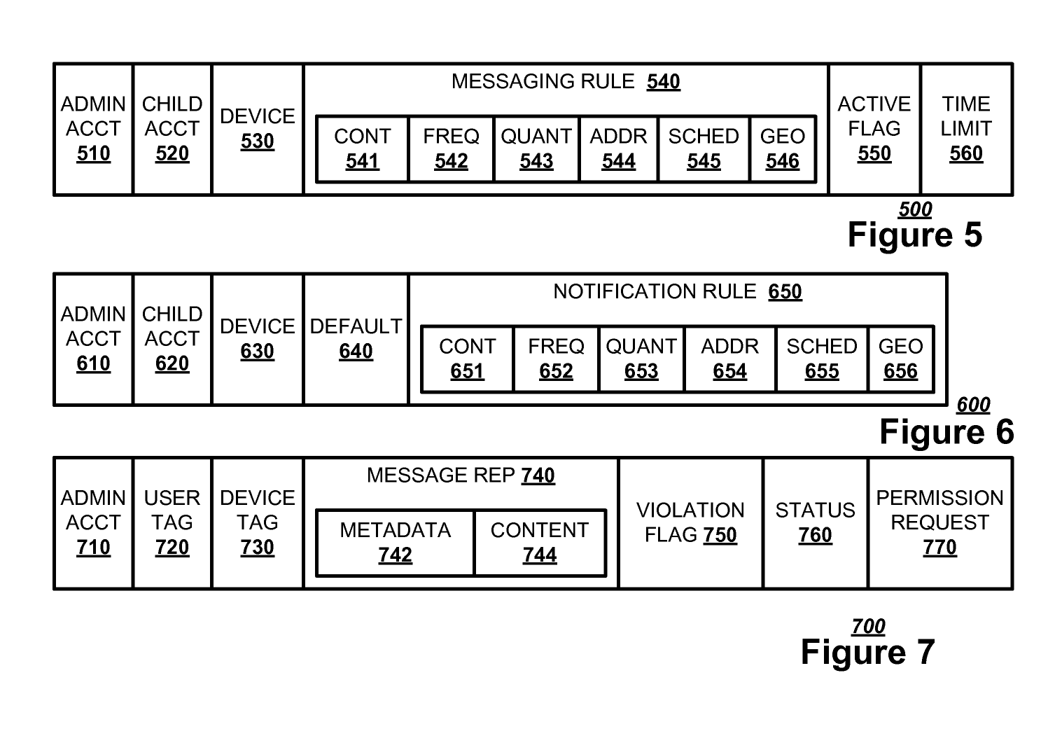

The administrative user may send an administrative messaging rule instruction to the administrative network service account for transference to the child network service account. FIG. 5 illustrates, in a block diagram, one embodiment of an administrative messaging rule instruction 500. The administrative messaging rule instruction 500 may have an administrative network service account identifier 510 indicating the administrative user sending the administrative messaging rule. The administrative messaging rule instruction 500 may have a child network service account identifier 520 indicating the child user subject to the administrative messaging rule. The administrative messaging rule instruction 500 may have a child user device identifier 530 indicating the child user device subject to the administrative messaging rule. The administrative messaging rule instruction 500 may have an administrative messaging rule 540 indicating a set of one or more policies to be satisfied before exchanging a device message via the child user device.

The administrative messaging rule 540 may list a content filter 541, a frequency cap 542, a quantity cap 543, an address list 544, a messaging schedule 545, a geographic limitation 546, or other messaging policy. A content filter 541 limits the type of content that may be exchanged in a device message, such as sexually explicit text or images. A frequency cap 542 limits the number of device messages that may be exchanged in a set period of time. A quantity cap 543 limits the total number of device messages that may be exchanged, such as for a given billing period to avoid overage fees. An address list 544 limits the devices that may exchange a device message with the child user device. The address list 544 may be a whitelist describing those users that a child user may contact or a blacklist describing those users that a child user is forbidden from contacting. A messaging schedule 545 identifies times when a device message may be exchanged, such as blocking messages after ten at night or just allowing messages for two hours after school. A geographic limitation 546 lists the geographic locations where the child user device may exchange device messages or the geographic locations where the child user device is prevented from exchanging device messages. The administrative messaging rule 540 may combine various policies. For example, during certain times in the messaging schedule 545 or outside the geographic limitation 546, the child user device may limit the exchange of device messages to only certain users on the address list 544, such as parents or emergency professionals.

The administrative messaging rule instruction 500 may have an active monitoring flag 550 indicating that, rather than automatically banning device messages that fail to meet the policies set in the administrative messaging rule, the child network service account is to seek approval from the administrative user. Alternately, the administrative messaging rule instruction 500 may have an active monitoring rule describing device messages that are to be approved by the administrative user before exchange with the child user device. The active monitoring rule may list alternate values for the messaging policies of the administrative messaging rule 540. The administrative messaging rule instruction 500 may have a response time limit 560. If the administrative user does not respond within the time limit, the independent child user device may default to blocking or allowing the device message as previously set by the administrative user.

The administrative user may send a notification rule instruction to the administrative network service account to establish notification policy for alerting the administrative user to device messages of the independent child user device. FIG. 6 illustrates, in a block diagram, one embodiment of a notification rule instruction 600. The notification rule instruction 600 may have an administrative network service account identifier 610 indicating the administrative user sending the notification rule. The notification rule instruction 600 may have a child network service account identifier 620 indicating the child user subject to the notification rule. The notification rule instruction 600 may have a child user device identifier 630 indicating the child user device subject to the notification rule. The notification rule instruction 600 may have a default flag 640 indicating the network service or the independent child user device may default to sending a notification whenever an administrative messaging rule is violated.

Alternately, the notification rule instruction 600 may have a notification rule 650 indicating a set of one or more criteria to be satisfied before notifying an administrative user of a device message sent from the child user device. The notification rule 650 may list a content trigger 651, a frequency threshold 652, a quantity threshold 653, an address list 654, a schedule trigger 655, a geographic trigger 656, or other notification trigger. A content trigger 651 notifies an administrative user when a specified type of content is sent in a device message, such as sexually explicit text or images. A frequency trigger 652 notifies an administrative user when the number of device messages exceeds a specified number of messages sent in a specified period of time. A quantity trigger 653 notifies an administrative user when the total number of device messages exceeds a specified number, such as for a given billing period to avoid overage fees. An address list 654 may list a specified user or user device that, when exchanging a device message with the child user, triggers a notification to the administrative user. Alternately, the address list 654 may list users or user devices for which no notification is necessary, such as a parent or a relative. A schedule trigger 655 notifies an administrative user when the child user devices sends a device message during a specified time or outside of a specified time, such as after ten at night or on weeknights. A geographic trigger 656 notifies an administrative user when the child user device exchanges a device message within or outside of a geographic location.

The network service or the independent child user device may send a message report to the administrative user device requesting permission to exchange a device message. Alternately, the network service may store a message report in a child user history describing each device message sent from a child user device or any device message that violates an administrative messaging rule. FIG. 7 illustrates, in a block diagram, one embodiment of a message report 700. The message report 700 may have an administrative network service account identifier 710 indicating the administrative user that may view the message report 700. The message report 700 may have a visual user tag 720 that visually represents the child user that sent or received the device message when presented to the administrative user. The message report 700 may have a visual device tag 730 that visually represents the child user device that sent or received the device message when presented to the administrative user. The message report 700 may have a message representation 740 of the device message. The message representation 740 may have at least one of a metadata description 742 of the device message and a content copy 744 of the device message. The metadata description 742 may describe non-content aspects of the device message, such as the recipient, the sender, the time sent or received, and the data size of the device message. The content copy 744 may reproduce of a copy of the content sent in the device message, such as any text, audio files, digital images, or video files. The message report 700 may have a violation flag 750 indicating whether the device message violated any of the administrative messaging rules established by the administrative user. While presumably a device message that violates the administrative messaging rule is not sent, a status flag 760 may be included indicating the actual status of the device message, such as sent, blocked, or pending. In an active monitoring situation, the message report 700 may include a permission request 770 asking the administrative user to approve the exchange of the device message.

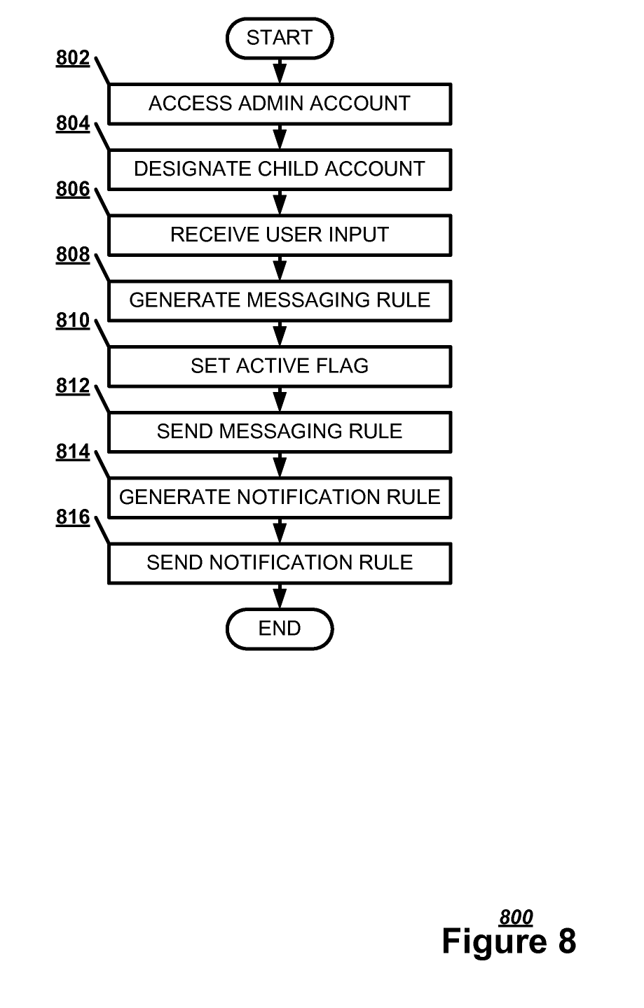

FIG. 8 illustrates, in a flowchart, one embodiment of a method 800 of establishing an administrative messaging rule with an administrative user device. The administrative user device may access an administrative network service account on a network service (Block 802). The administrative user device may designate a different network service account as a child network service account (Block 804). The administrative user device may receive a user input describing at least one of a content filter or a content trigger, a frequency cap or a frequency threshold, a quantity cap or a quantity threshold, an address list, a messaging schedule or a schedule trigger, and a geographic limitation or a geographic trigger for an administrative messaging rule or a notification rule (Block 806). The administrative user device may generate from the user input an administrative messaging rule for implementation when a child user exchanges a device message via an independent child user device (Block 808). The administrative user device may set an active monitoring flag indicating whether the administrative user prefers to passively or actively monitor the child user device (Block 810). The administrative user device may send the administrative messaging rule to the administrative network service account for application to the independent child user device via the child network service account (Block 812). The administrative user device may generate from the user input a notification rule describing at least one of a content trigger, a frequency threshold, a quantity threshold, an address list, a schedule trigger, and a geographic trigger (Block 814). The administrative user device may send a notification rule to the administrative network service account (Block 816).

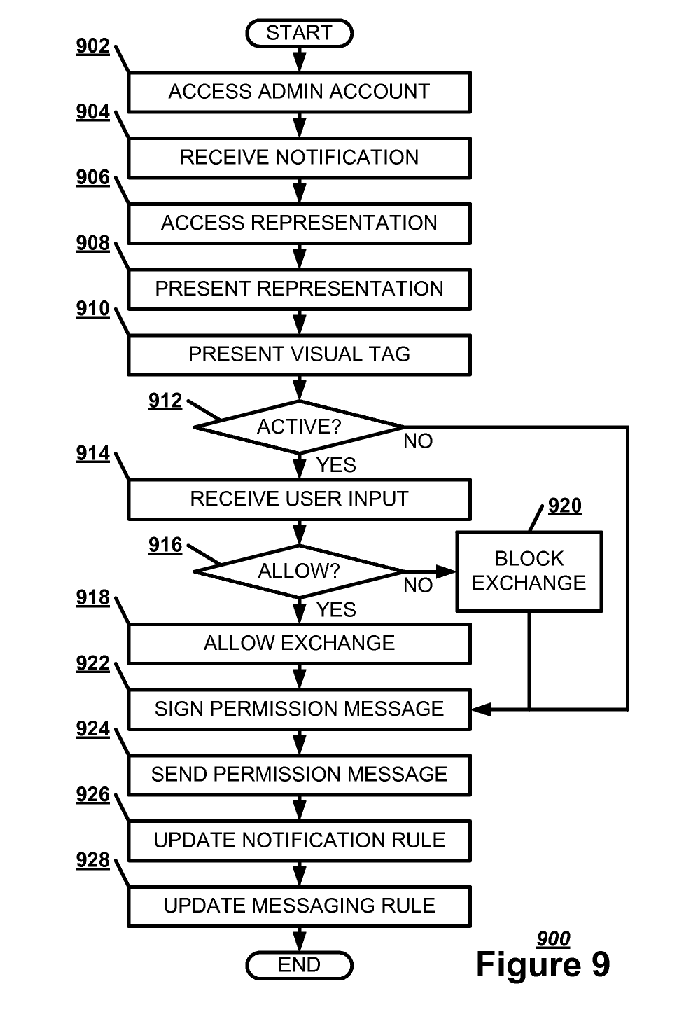

FIG. 9 illustrates, in a flowchart, one embodiment of a method 900 of monitoring device messaging with an administrative user device. The administrative user device may access an administrative network service account on a network service (Block 902). The administrative user device may receive a message notification regarding a device message in the administrative network service account (904). The administrative user device may access a message representation of the device message having at least one of a metadata description of the device message and a content copy of the device message in the administrative network service account (906). The administrative user device may present the message representation to the administrative user (Block 908). The administrative user device may present at least one of a visual user tag and visual device tag with the message representation of the device message (Block 910).

If the administrative user has requested active monitoring of the child user device (Block 912), the administrative user device may receive a user input allowing or denying exchange of the device message (Block 914). If the administrative user indicates that the exchange of the device message is to be allowed (Block 916), the administrative user device may generate an exchange permission message to the administrative network service account allowing the exchange (Block 918). If the administrative user indicates that the exchange of the device message is to be denied (Block 916), the administrative user device may generate an exchange permission message to the administrative network service account blocking the exchange (Block 920). The administrative user device may digitally sign the exchange permission message to prevent spoofing (Block 922). The administrative user device may send the exchange permission message either directly to the independent child user device or to the network service for transmission to the independent child user device (Block 924). If the administrative user wants to alter either the administrative messaging rule or the notification rule, the administrative user device may update the notification rule with the administrative network service account (Block 926). The administrative user device may update the administrative messaging rule with the administrative network service account (Block 928).

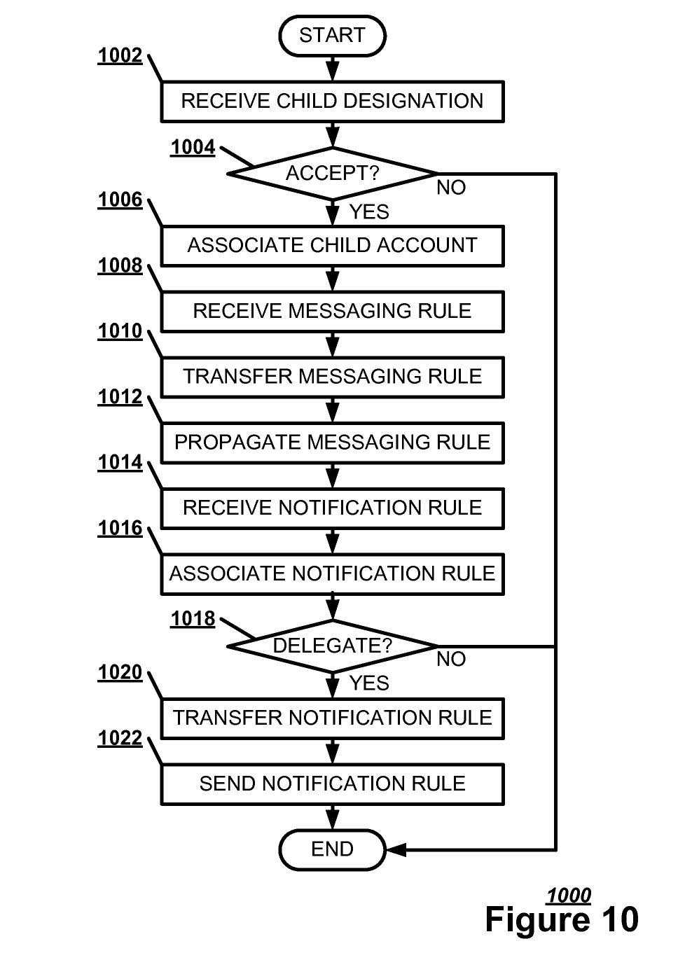

FIG. 10 illustrates, in a flowchart, one embodiment of a method 1000 of establishing an administrative messaging rule with a network service. The network service may receive from the administrative network service account a child designation for a different network service account (Block 1002). If the designated network service account accepts this designation (Block 1004), the network service may associate the administrative network service account with the child network service account (Block 1006). The network service may receive an administrative messaging rule from an administrative user device (Block 1008). The network service may transfer the administrative messaging rule from the administrative network service account to the child network service account (Block 1010). The network service may propagate the administrative messaging rule to an independent child user device for implementation when a child user exchanges a device message via the independent child user device (Block 1012). The network service may send the administrative messaging rule to a rule broker resident in a messaging application of the independent child user device. Alternately, the network service may send the administrative messaging rule to a rule broker resident in an operating system of the independent child user device.

The network service may receive a notification rule from an administrative user device (Block 1014). The network service may apply the notification rule or may delegate administration of the notification rule to the independent client user device. The network service may associate the notification rule with the child network service account (Block 1016). If the network service chooses to delegate (Block 1018), the network service may transfer the notification rule to the child network service account (Block 1020). The network service may propagate the notification rule to the independent child user device for implementation when sending a device message sent from the independent child user device (Block 1022).

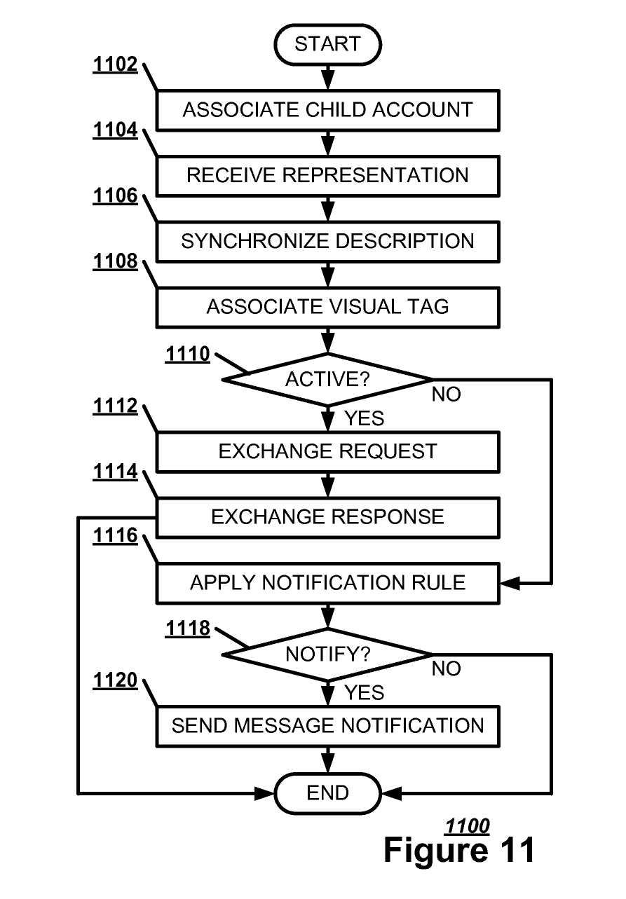

FIG. 11 illustrates, in a flowchart, one embodiment of a method 1100 of monitoring device messaging with a network service. The network service may associate an administrative network service account with a child network service account (Block 1102). The network service may receive a message representation of a device message from an independent child user device in the child network service account (Block 1104). The network service may synchronize the message representation of the device message from the child network service account to the administrative network service account (Block 1106). The network service may associate at least one of a visual user tag and visual device tag with the message representation in the administrative network service account (Block 1108).

If the administrative messaging rule has indicated that the administrative user has requested active monitoring of device messages (Block 1110), the network service may exchange a permission request from the child network service account to the administrative network service account for transmission to the administrative user device (Block 1112). The network service may exchange a permission response from the administrative network service account to the child network service account for transmission to the child user device (Block 1114).

The network service may apply a notification rule to the device message (Block 1116). If the notification rule indicates the administrative user is to be notified (Block 1118), the network service may send a message notification regarding the device message to an administrative user device (Block 1120). The message notification may contain a copy of the content of the device message or may contain a metadata description of the message.

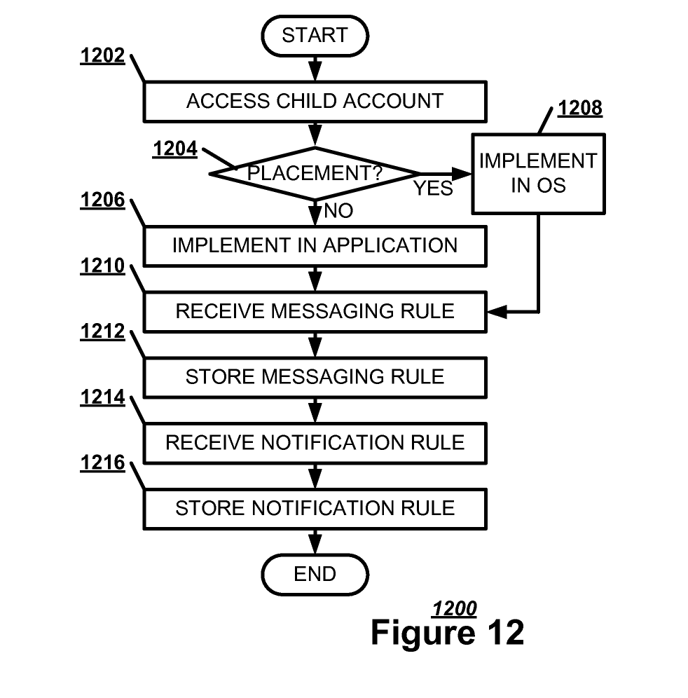

FIG. 12 illustrates, in a flowchart, one embodiment of a method 1200 of establishing an administrative messaging rule with an independent child user device. The independent child user device may access a child network service account of the network service (Block 1202). If the independent child user device prefers to place the rule broker to localize the administrative messaging rules to a messaging application (Block 1204), the independent child user device may implement a rule broker resident in the messaging application of the computing device to apply an administrative messaging rule (Block 1206). If the independent child user device prefers to place the rule broker to provide greater coverage of messaging applications (Block 1204), the independent child user device may implement a rule broker resident in an operating system of the computing device to apply an administrative messaging rule (Block 1208). The independent child user device may receive from the child network service account the administrative messaging rule transferred from an administrative network service account (Block 1210). The independent child user device may store the administrative messaging rule for implementation in exchanging a device message (Block 1212). The independent child user device may receive from the child network service account a notification rule transferred from an administrative network service account (Block 1214). The independent child user device may store the notification rule for implementation in exchanging a device message (Block 1216).

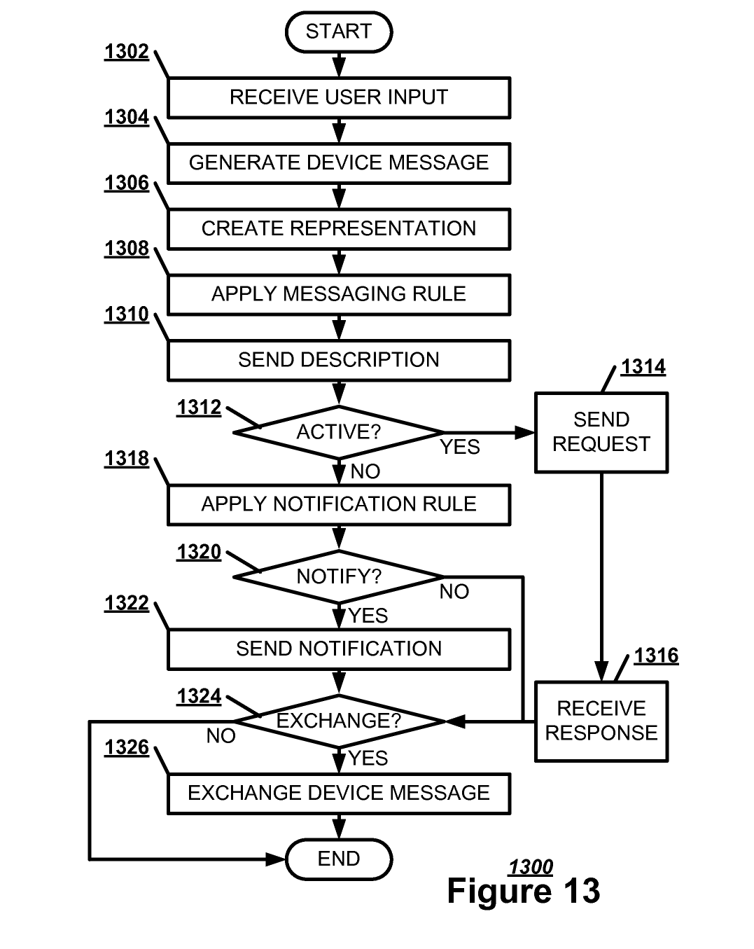

FIG. 13 illustrates, in a flowchart, one embodiment of a method 1300 of device messaging with an independent child user device. The independent child user device may receive a user input to create a device message (Block 1302). The independent child user device may generate the device message for transmission on a cellular network or a data network (Block 1304). The independent child user device may create a message representation of the device message having at least one of a metadata description of the device message and a content copy of the device message to be sent to the child network service account for synchronization with the administrative network service account (Block 1306). The independent child user device may apply the administrative messaging rule when a child user exchanges the device message via the computing device (Block 1308). The independent child user device may send the message representation of the device message to the child network service account for synchronization with the administrative network service account (Block 1310). If the administrative messaging rule indicates that any exchange of a device message is to be actively monitored (Block 1312), the independent child user device may send to the administrative user device a permission request asking for permission to exchange the device message, either via the network service or independently (Block 1314). The independent child user device may receive from the administrative user device a permission response indicating whether the administrative user has allowed or denied the permission request (Block 1316).

The independent child user device may apply a notification rule to the device message (1318). If the notification rule indicates that a message notification is to be sent (Block 1320), the independent child user device may send the message notification regarding the device message to an administrative user device (Block 1322). If the device message is compliant with the administrative messaging rule or if the administrative user has approved (Block 1324), the independent child user device may exchange the device message (Block 1326).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer- executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A network service server, comprising:
a memory configured to associate an administrative network service account with a child network service account;
a processing core having at least one processor configured to transfer an administrative messaging rule from the administrative network service account to the child network service account; and
a communications interface configured to propagate the administrative messaging rule to an independent child user device for implementation when a child user exchanges a device message via the independent child user device.

2. The network service server of claim 1, wherein the administrative messaging rule is at least one of a content filter, a frequency cap, a quantity cap, an address list, a messaging schedule, and a geographic limitation.

3. The network service server of claim 1, wherein the communications interface is further configured to send the administrative messaging rule to a rule broker resident in at least one of a messaging application and an operating system of the independent child user device.

4. The network service server of claim 1, wherein the communications interface is further configured to receive the administrative messaging rule from an administrative user device.

5. The network service server of claim 1, wherein the communications interface is further configured to receive a message representation of the device message from the independent child user device in the child network service account.

6. The network service server of claim 1, wherein a message representation of the device message has at least one of a metadata description of the device message and a content copy of the device message.

7. The network service server of claim 1, wherein the processing core is further configured to synchronize a message representation of the device message from the child network service account to the administrative network service account.

8. The network service server of claim 1, wherein the memory is further configured to associate at least one of a visual user tag and a visual device tag with a message representation of the device message in the administrative network service account.

9. The network service server of claim 1, wherein the communications interface is further configured to receive a notification rule from an administrative user device.

10. The network service server of claim 1, wherein the processing core is further configured to apply a notification rule to the device message.

11. The network service server of claim 1, wherein a notification rule is at least one of a content trigger, a frequency threshold, a quantity threshold, an address list, a schedule trigger, and a geographic trigger.

12. The network service server of claim 1, wherein the communications interface is further configured to send a message notification regarding the device message to an administrative user device.

13. A computing device, having a memory to store an administrative messaging rule, the computing device configured to access a child network service account, the computing device further configured to receive from the child network service account the administrative messaging rule transferred from an administrative network service account, and the computing device also configured to apply the administrative messaging rule when a child user exchanges a device message via the computing device.

14. The computing device of claim 13, wherein the computing device is further configured to implement a rule broker resident in a messaging application of the computing device to apply the administrative messaging rule.

15. The computing device of claim 13, wherein the computing device is further configured to implement a rule broker resident in an operating system of the computing device to apply the administrative messaging rule.

16. The computing device of claim 13, wherein the computing device is further configured to exchange the device message when compliant with the administrative messaging rule.

17. The computing device of claim 13, wherein the computing device is further configured to create a message representation of the device message having at least one of a metadata description of the device message and a content copy of the device message to be sent to the child network service account for synchronization with the administrative network service account.

18. The computing device of claim 13, wherein the computing device is further configured to send to the administrative user device a permission request asking for permission to exchange the device message.

19. A machine-implemented method, comprising:
accessing an administrative network service account;
generating an administrative messaging rule for implementation when a child user exchanges a device message via an independent child user device;
sending the administrative messaging rule to an administrative network service account for application to the independent child user device via a child network service account; and
accessing a message representation of the device message having at least one of a metadata description of the device message and a content copy of the device message in the administrative network service account.

20. The method of claim 19, further comprising:
generating a notification rule describing at least one of a content trigger, a frequency threshold, a quantity threshold, an address list, a schedule trigger, and a geographic trigger;
sending the notification rule to the administrative network service account; and
receiving a message notification regarding the device message in the administrative network service account.
